(19) United States
(12) Patent Application Publication
(10) Pub. No.: US 2006/0241904 A1
(43) Pub. Date: Oct. 26, 2006

(54) Determination of standard deviation

(76) Inventor: John S. Middleton, Fullerton, CA (US)

Correspondence Address: SHELDON & MAK PC, 225 SOUTH LAKE AVENUE, 9TH FLOOR, PASADENA, CA, 91101, US

(21) Appl. No.: 11/115,523

(22) Filed: Apr. 26, 2005

(51) Int. Cl. G06F 19/00

(52) U.S. Cl. 702/181

(57) ABSTRACT

One embodiment of the invention provides a method for determining the standard deviation of a data sample. The method considers the distribution of the data in the context of cumulative probability. The empirical probability of a plurality of values is determined. The quantiles of the normal distribution for each empirical probability is then obtained. A robust linear regression of the quantiles versus the plurality of values is performed. Then the slope of the robust linear regression is determined and the inverse of the slope serves as an estimate of the standard deviation.

### FIELD

One embodiment of the invention pertains to a method for improving the robustness of calculating a standard deviation by performing a robust linear regression on data expressed in the form of cumulative probability.

### BACKGROUND

Standard deviations are typically used in analyzing measurement data. A standard deviation is a statistical measure of variance from the mean value, and is known as the “root mean square deviation”. The standard deviation measures the degree to which individual numbers tend to spread about their mean, or average, value. The “mean” is commonly understood in the art to be the average of a set of values. The “mode” is commonly understood in the art to be the value that occurs most often in a set of values. As used in this application, the “magnitude” is the difference between the largest value and the smallest value in a range of values. As used in this application, “quantiles” are values that divide the data points or measurement distribution such that there is a given proportion of measurements or data points below the quantile.

The conventional calculation of the standard deviation of a data set is represented by the equations: SD=Σ(xᵢ−xₘₑₐₙ)²/(n−1). FIG. 1 illustrates a histogram of the distribution of ten thousand (10000) data samples that was generated such that the true standard deviation of the data samples was two (2). Each data sample was generated from a set of ninety-nine (99) random numbers with a mean of one hundred (100) and a standard deviation of two (2) and one random number with a mean of one hundred (100) and a standard deviation of ten (10). This histogram has a mean (which is equal to the square root of the average standard deviation squared) of 2.23, a mode of approximately 2.06, and a range from 1.53 to 4.46 with a magnitude of 2.93.

In assessing the performance of measurement instrumentation and other instances where statistical probabilities are employed, it is sometimes useful to determine the standard deviation of measured data points. However, because of the nature of measurement instruments and measure data, stray data points are sometimes measured. These stray data points are measurements that may be polluted or erroneous and thus significantly diverge from the rest of the measurements.

### SUMMARY OF THE INVENTION

One embodiment of the invention provides a method for determining the standard deviations of a data sample. The method considers the distribution of the data in the context of cumulative probability. The empirical probability of a plurality of values is determined. The quantiles of the normal distribution for each empirical probability is then obtained. A robust linear regression of the quantiles versus the plurality of values is performed to obtain a standard deviation. The inverse of the slope of the robust linear regression serves as an estimate of the standard deviation.

One embodiment of the invention provides a method for determining a standard deviation of a set of values by (a) obtaining a plurality of values, (b) determining the empirical probability of each of the plurality of values, (c) determining the quantiles of the normal distribution for each empirical probability, and (d) performing a robust linear regression of the quantiles versus the plurality of values to obtain a standard deviation. The slope of the robust linear regression is obtained and the inverse of the slope serves as an estimate of the standard deviation.

### BRIEF DESCRIPTION OF THE DRAWINGS

FIG. 1 illustrates a histogram of the distribution of ten thousand (10000) standard deviations that were generated. Each standard deviation was determined using the traditional method. The true standard deviation of each data sample was two (2).

FIG. 2 illustrates another histogram of standard deviations for ten thousand data samples. These standard deviations were determined using an existing robust estimation method.

FIG. 3 illustrates a method of linearizing data points and applying a linear regression to obtain a more accurate standard deviation of the data points according to one embodiment of the invention.

FIG. 4 illustrates a cumulative probability plot of data points versus their corresponding quantiles according to one embodiment of the invention.

FIG. 5 illustrates a histogram of standard deviations for ten thousand data samples determined according to the method described in FIG. 3.

### DETAILED DESCRIPTION

In the following description numerous specific details are set forth in order to provide a thorough understanding of the invention. However, one skilled in the art would recognize that the invention might be practiced without these specific details. In other instances, well known methods, procedures, and/or components have not been described in detail so as not to unnecessarily obscure aspects of the invention.

One embodiment of the invention relates to an improved method for calculating standard deviation. The method considers the distribution of the data in the context of cumulative probability. Such a method may be useful in characterizing the performance of clinical instrumentation and other instances where statistical estimates of scale are employed.

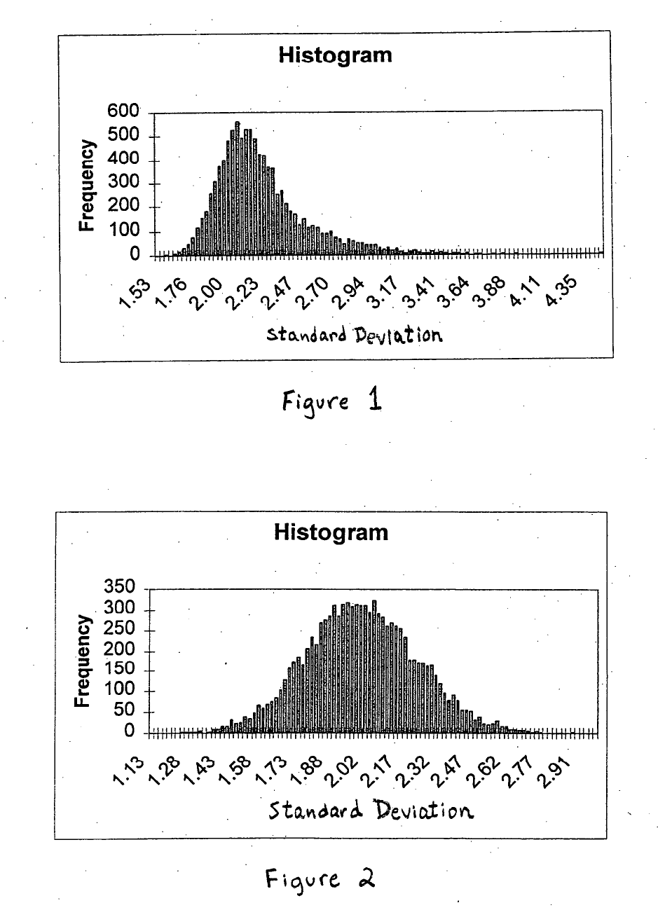

For purposes of this illustration, a data sample of one hundred (100) data points is randomly generated such that the true standard deviation of the data sample is two (2). The data sample is then polluted with one measurement that is not part of the true data distribution. This process is then repeated to create ten thousand (10,000) data samples. FIG. 1 illustrates a histogram of ten thousand (10,000) randomly generated estimates of standard deviation corresponding to the ten thousand (10,000) data samples. This distribution of standard deviation values is characteristic of the traditional method for estimating standard deviation (SD=Σ(xᵢ−xₘₑₐₙ)²/(n−1)). While this example is performed using one hundred randomly generated data points per data sample, it may also be done using any other number of generated, measured, or derived data points having any standard deviation. As employed herein, “x” represents a data sample having one hundred (100) points or values. The data points may be obtained from one or more tests, observations, measurements, etc.

FIG. 2 illustrates another histogram standard deviations for ten thousand data samples determined using a robust estimation method. For example, a powerful statistical analysis toolkit like S-PLUS® made by Insightful Corporation, a Delaware Corp., may be used to implement such robust estimation methods. One embodiment of the invention may apply the S-PLUS® “mad” function, which receives a vector of n data points (i.e., the one hundred data points) and takes the median as the center of the data to provide a standard deviation. Then the resulting standard deviation is scaled to be consistent with the standard deviation of the Gaussian model. For the ten thousand randomly generated data samples having a standard deviation of two (2), having polluted values, this robust estimation method for standard deviation provides a mean of 2.01 a mode of approximately 2.06 and a range from 1.13 to 2.99 with a magnitude of 1.85.

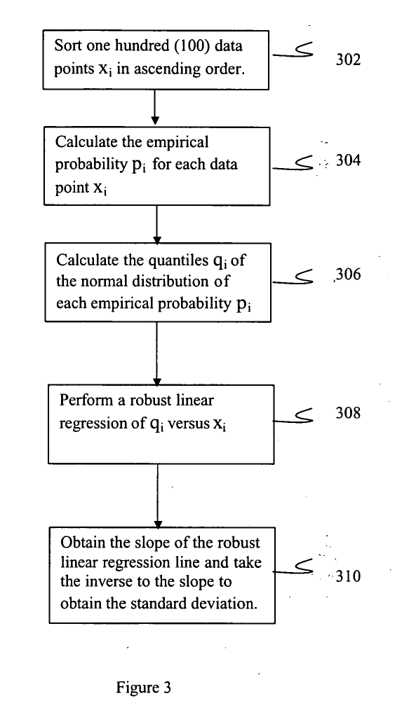

FIG. 3 illustrates a method of linearizing data points and applying a linear regression to obtain a more accurate standard deviation of the data points according to one embodiment of the invention. First, data points xᵢ are sorted in ascending order 302. Then, the empirical probability pᵢ is calculated for each data point 304 by the equation:
pᵢ=(i−0.5)/100
For each empirical probability pᵢ a quantile qᵢ of the normal distribution is determined 306 by solving the equation

$${p}_{i} ( 1 / 2 \text{∏} ) {\int }_{- ∞}^{qi} {ⅇ}^{- {x}^{2} / x} ⅆ x$$

By determining the empirical probability and then using it to calculate the standard deviation, the effect of stray data values on the standard deviation is effectively reduced or minimized.

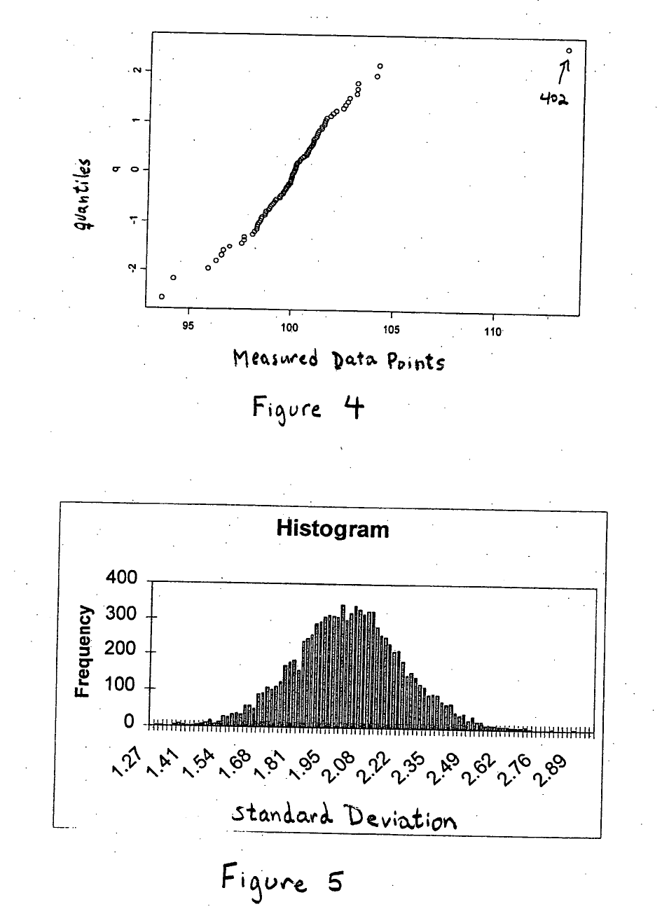

A cumulative probability plot may be obtained by using xᵢ and qᵢ as illustrated in FIG. 4. However, such cumulative probability plot is still susceptible to stray data points 402. Such stray data points tend to affect the accuracy of the standard deviation calculation for the data points.

To further counter the effect of stray data points, a robust linear regression is performed on a plot of the data samples xᵢ versus quantiles qᵢ 308. The reciprocal of the slope of this regression line is an estimate of the standard deviation 310. This plot of data sets xᵢ versus quantiles qᵢ is commonly known as a cumulative probability plot. Data that falls along the line in such a plot is normally distributed and stray data points that do not fall along the line is effectively ignored in the estimate of the standard deviation. Standard deviations may then be obtained for each data sample using this method.

FIG. 5 illustrates a histogram of standard deviations for ten thousand data samples determined according to the method described in FIG. 3. It is important to note that the data graphed in this histogram has a mean of 2.03, a mode of approximately 2.00, and a range from 1.27 to 2.96 with a magnitude of 1.69. Thus, the method of the present invention for determining standard deviations is superior to the conventional methods and, at least one, robust estimation method for determining standard deviations.

Table 1 illustrates the result of these three methods. The method of the present invention is comparable to the other robust method with respect to average/mode the standard deviation determined and superior with respect to the confidence in the estimate of the standard deviation, as measured by the range of values (maximum - minimum).

TABLE 1

| Method | Mean | Mode | Min | Max | Range |
|---|---|---|---|---|---|
| Conventional | 2.23 | 2.06 | 1.53 | 4.46 | 2.93 |
| S-PLUS ® | 2.01 | 2.06 | 1.13 | 2.99 | 1.85 |
| Present | 2.03 | 2.00 | 1.27 | 2.96 | 1.69 |
| Invention | | | | | |

The narrower magnitude obtained using the method of the present invention indicates a greater accuracy in determining the standard deviation for a given set of data points.

According to various embodiments of the invention, the methods described herein may be embodied in a computer readable medium or storage medium, such as an optical disc, a hard drive, a magnetic storage medium, a programmable storage device, or other medium.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled, in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. A method for determining a standard deviation of a set of values, comprising the steps of:
(a) obtaining a plurality of values;
(b) determining the empirical probability of each of the plurality of values;
(c) determining the quantiles of the normal distribution for each empirical probability;
(d) performing a robust linear regression of the quantiles versus the plurality of values to obtain a standard deviation; and
(e) determining the standard deviation by obtaining the inverse of the slope of the robust linear regression.

2. The method of claim 1 further comprising:
generating a cumulative probability plot of the quantiles versus the plurality of values and performing the robust linear regression on the cumulative probability.

3. The method of claim 1 wherein the effect of any stray data value on the standard deviation is effectively reduced by use of the empirical probabilities.

4. A method for estimating a standard deviation of a sample of values, comprising the steps of:
(a) obtaining a plurality of data samples, each data sample including a plurality of values;
(b) determining the empirical probability of each of the plurality of data samples;
(c) generating a cumulative probability data set for each of the plurality of data samples;
(d) performing a linear regression on the cumulative probability data sets and corresponding plurality of data samples.

5. The method of claim 4 further comprising:
determining the slope of the linear regression; and
determining the inverse of the slope to obtain an estimate of the standard deviation.

6. The method of claim 4 further comprising:
determining the quantiles of the normal distribution for each empirical probability; and
performing a robust linear regression of the quantiles versus the plurality of data samples.

7. The method of claim 4 further comprising:
obtaining a standard deviation for each data sample; and
averaging the standard deviations squared for the plurality of data samples; and
determining the square root of that average to obtain a single standard deviation estimate.

8. A machine-readable medium having one or more instructions for determining a standard deviation for a plurality of values, which when executed by a processor, causes the processor to perform operations comprising:
(a) obtaining a plurality of data sets each data set including a plurality of values;
(b) determining the empirical probability of each of the plurality of values;
(c) determining the quantiles of the normal distribution for each empirical probability;
(d) performing a robust linear regression of the quantiles versus the plurality of values to obtain a standard deviation; and
(e) determining the standard deviation by obtaining the inverse of the slope of the robust linear regression

9. The machine-readable medium of claim 8 further comprising:
generating a cumulative probability plot of the quantiles versus the plurality of values, wherein the effect of any stray data value on the standard deviation is effectively reduced by use of the empirical probabilities.

10. The machine-readable medium of claim 8 further comprising:
obtaining a standard deviation for each data set; and
averaging the standard deviations squared for the plurality of data sets; and determining the square root of that average to obtain a single standard deviation estimate.
